(19) United States
(12) Patent Application Publication
(10) Pub. No.: US 2014/0177383 A1
(43) Pub. Date: Jun. 26, 2014

(54) Homogeniser

(71) Applicant: Thomas Porep, Grossenbrode (DE)

(72) Inventor: Thomas Porep, Grossenbrode (DE)

(21) Appl. No.: 13/637,573

(22) PCT Filed: Mar. 16, 2011
(86) PCT No.: PCT/DE2011/000263

§ 371 Date: Jul. 10, 2013

(30) Foreign Application Priority Data
Mar. 29, 2010 (DE) 10 2010 013 105.9

(51) Int. Cl. B01F 7/00

(52) U.S. Cl. CPC B01F 7/00716
USPC 366/286

(57) ABSTRACT

The invention relates to a homogeniser having an inlet leading into a homogenisation chamber, an outlet leading out of the homogenisation chamber, a stator and a rotor head generating shear forces together with the stator, wherein the stator and the rotor head are arranged in the homogenisation chamber, a rotor shaft connected to the rotor head, and a motor driving the rotor shaft. The homogeniser is characterised by a sleeve having an internal thread and rotatably connected to the rotor head, which sleeve screws onto an external thread formed on the rotor shaft in order to adjust the dimension of the gap between the stator and the rotor head, and a fixing means arrangement for fixing the sleeve on the rotor shaft.

The invention relates to a homogeniser having an inlet leading into a homogenisation chamber, an outlet leading out of the homogenisation chamber, a stator and a rotor head generating shear forces together with the stator, wherein stator and rotor head are arranged in the homogenisation chamber, a rotor shaft connected to the rotor head, and a motor driving the rotor shaft.

The invention relates in particular to a homogeniser for homogenising marine diesel oil and heavy oil and for producing fuel/water and fuel/fuel emulsions.

Homogenisers for preventing oil sludge residues, for improving the combustion of fuel and for reducing nitrogen oxide emissions by producing and using fuel/water or water/fuel emulsions are generally known.

A particular problem with these known homogenisers consists in the fact that on account of partly very small dimensions of the gaps also tightly limited production tolerances have to be complied with. In particular in the case of a dimension of the gap that is uniform across the circumference of the rotor, this requires a lot of work.

Conventionally, the dimension of the gap, that is to say the space between the rotor head and the stator, is adapted by changing the end position of the rotor by means of adjusting washers. This adaptation is usually connected with a high degree of work, since the homogeniser has to be opened and the rotor shaft exposed.

A disadvantage of the known homogeniser is therefore the amount of work and the relatively long downtimes connected with the adaptation work.

It is therefore the object of the invention to provide a homogeniser where adaptation of the dimension of the gap is made possible with only little effort and only short downtimes.

This object is achieved by the homogeniser having the features of claim 1. The sub claims specify advantageous embodiments of the invention.

The basic idea of the invention consists in replacing the usually rigid connection of rotor shaft and rotor head by a screw connection so that the rotor shaft can be shifted axially on the rotor shaft to a desired dimension of the gap and fixed in this position. Here it is particularly advantageous that—the homogeniser else being designed as is conventional—the adaptation of the dimension of the gap can take place through the inlet since the adjusting sleeve and its locking are arranged on the end face of the rotor head.

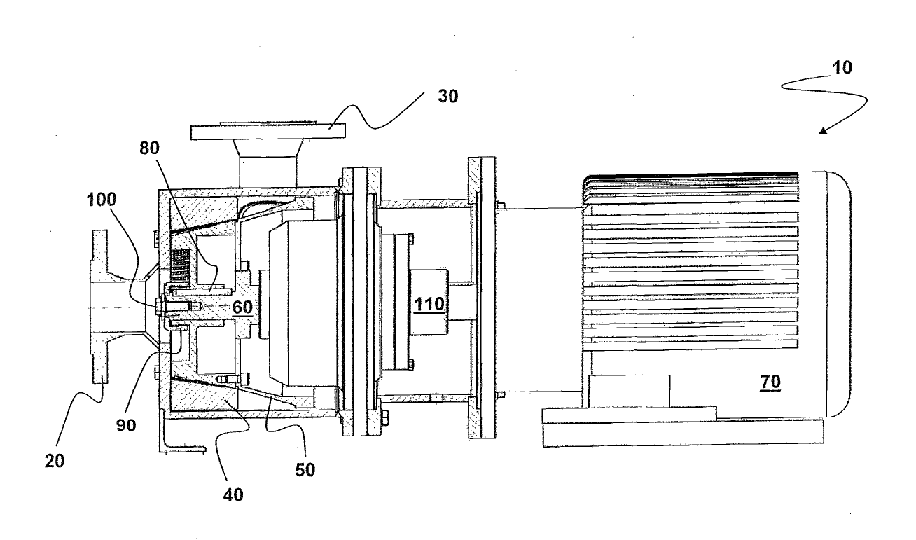

The invention is explained in more detail using an exemplary embodiment that is shown in the sole FIG. 1 and is of particularly preferred design:

FIG. 1 shows an exemplary embodiment of the invention of particularly preferred design. FIG. 1 in particular shows a homogeniser 10 having an inlet 20 leading into a homogenisation chamber, an outlet 30 leading out of the homogenisation chamber, a stator 40 and a rotor head 50 generating shear forces together with the stator 40, the stator 40 and the rotor head 50 being arranged in the homogenisation chamber or forming the latter, a rotor shaft 60 connected to the rotor head 50 and a motor 70 driving the rotor shaft 60.

According to the invention, the dimension of the gap between the stator 40 and the rotor head 50 can be changed in that the routor head 50 is designed to be shiftable on the rotor shaft 60 in the axial direction, the rotor head 50 exhibiting a centrally arranged opening receiving the rotor shaft 60 and the rotor head 50 and the rotor shaft 60, forming a spline or a parallel key 80 for optimum force transfer of the rotational movement of the rotor shaft 60 to the rotor head 50. Therefore special care has to be taken that the spline or the parallel key 80 is formed across the entire axial section in which the rotor head 50 can be shifted across the rotor shaft 60.

To enable an adjustment of the dimension of the gap between the stator 40 and the rotor head 50 that is as precise as possible, the rotor head 50 is shifted on the rotor shaft 60 by means of a screw movement along the axis of the rotor shaft 60, however it not being necessary for this purpose to rotate the entire rotor head 50, but only a sleeve 90 that is rotatably fastened on the rotor head 50 and exhibits an internal thread at least in a part section that screws with an external thread provided on the rotor shaft 60. Thus the position of the sleeve 90 on the rotor shaft 60 determines the position of the rotor head 50 on the rotor shaft and thus also the dimension of the gap between the rotor head 50 and the stator 40.

To prevent an unintended change in position of the sleeve 90 on the rotor shaft 60 during the operation of the homogeniser 10 that occurs spontaneously due to the forces acting inside the homogeniser, a fixing means 100 for fixing the sleeve 90 on the rotor shaft 60 is provided. This fixing means 100 locks the sleeve 90 so that, if necessary, taking into account the direction of rotation of the rotor shaft 60 and the direction of the rotor thread arranged on the rotor shaft 60, no twisting of the sleeve 90 can take place.

In a particularly preferred manner, the fixing means 100 consists of a tapped hole introduced axially in the rotor shaft 60 and a screw that screws with the tapped hole and presses the sleeve 90 against the rotor shaft 60.

So that it is easy to tighten the fixing means 100 without the rotor shaft 60 co- rotating and making it difficult to tighten the fixing means 100, a further fixing means 110 for fixing the rotor shaft 60 is provided. The further fixing means 110 can for example be a brake that immobilises the rotor shaft 60, or, if complex constructions are to be avoided, a recess that is provided on the outer circumference of the rotor shaft 60 and into which a means that prevents rotation of the rotor shaft 60, for example a bolt or a pin, can be inserted. In particular in FIG. 1 an opening is provided in the housing of the homogeniser 10 through which a rod can be inserted into the recess (in the area 110) provided on the rotor shaft 10 and so rotation of the rotor shaft 60 can be prevented.

It is particularly advantageous that the dimension of the gap can be set through the inlet 20 of the homogeniser 10 since positioning of the rotor head 50 takes place on the free end of the rotor shaft that is directed to the inlet 20. Likewise the fixing means 100 for fixing the position of the rotor head 50 on the rotor shaft 60 can be achieved through the inlet 20. Complicated work for adjusting the dimension of the gap, in particular opening the homogeniser 10 and the downtimes connected therewith, is dispensed with.

1. A homogeniser having
an inlet leading into a homogenisation chamber,
an outlet leading out of the homogenisation chamber,
a stator and a rotor head generating shear forces together with the stator, wherein stator and rotor head are arranged in the homogenisation chamber,
a rotor shaft connected to the rotor head,
and a motor driving the rotor shaft,
characterised by
a sleeve having an internal thread and rotatably connected to the rotor head, which sleeve screws onto an external thread formed on the rotor shaft in order to adjust the dimension of the gap between stator and rotor head, and
a fixing means for fixing the sleeve on the rotor shaft.

2. The homogeniser according to claim 1, characterised in that the rotor head and the rotor shaft are interconnected by means of a spline or a parallel key.

3. The homogeniser according to claim 1, characterised in that the fixing means consists of a tapped hole introduced axially into the rotor shaft and a screw screwing with a tapped hole and pressing the sleeve against the rotor shaft.

4. The homogeniser according to claim 1, characterised by a further fixing means for fixing the rotor shaft.

5. The homogeniser according to claim 4, characterised in that the further fixing means is a brake that immobilises the rotor shaft.

6. The homogeniser according to claim 4, characterized in that the further fixing means is formed from a recess provided on the outer circumference of the rotor shaft and a means that can be inserted into the recess and prevents rotation of the rotor shaft.
